(19) United States
(12) Patent Application Publication
(10) Pub. No.: US 2024/0096237 A1
(43) Pub. Date: Mar. 21, 2024

(54) Division Problems Education Device and Method of Use Thereof

(71) Applicant: James Lacroix, Brooklyn, NY (US)

(72) Inventor: James Lacroix, Brooklyn, NY (US)

(21) Appl. No.: 18/340,918

(22) Filed: Jun. 26, 2023

Related U.S. Application Data
(60) Provisional application No. 63/406,781, filed on Sep. 15, 2022.

(51) Int. Cl. G09B 23/02

(52) U.S. Cl. CPC G09B 23/02

(57) ABSTRACT

The present invention relates to a division problems education tool. The education tool is in the form of a physical or digital table having a grid including quotient values corresponding to a set of dividends (in a column) and divisors (in a row). More specifically, a top row has numbers spanning a sequential range from at least a second column to a fourteenth column to function as divisors; and a first column has numbers spanning a sequential range from at least a second row to a fourteenth row to function as dividends. A cell formed by an intersection corresponding to a row containing a dividend and a column containing a divisor includes the resultant quotient value of division of the dividend by the divisor. The table includes an indication of repeating and non-terminating quotient digits.

### CROSS-REFERENCE TO RELATED APPLICATION

The present application claims priority to, and the benefit of, U.S. Provisional Application No. 63/406,781, which was filed on Sep. 15, 2022, and is incorporated herein by reference in its entirety.

### FIELD OF THE INVENTION

The present invention relates generally to the field of education tools. More specifically, the present invention relates to novel division problems practice table device that can help students to learn and memorize division problems. The device comes in different sizes and can be physical or digital. The device has a table having dividends in a first column and divisors in a top row with the cells formed on intersection of the rows and columns having the quotient values. The device provides a visual representation of division problems that helps students to learn and memorize. Accordingly, the present disclosure makes specific reference thereto. Nonetheless, it is to be appreciated that aspects of the present invention are also equally applicable to other like applications, devices, and methods of manufacture.

### BACKGROUND

By way of background, mathematics is an area of knowledge that includes such topics as arithmetic, number theory, algebra, and more. Mathematics is considered as a difficult subject and many children have problems with math at school. This is especially true for elementary students who are beginning to advance into more involved functions, such as multiplication and division of whole numbers. In fact, of all the math operations, multiplication and division may be the hardest for children to learn. Tackling multiplication and division is the logical next step after addition and subtraction.

More than multiplication, elementary students struggle with division, and particularly with division numbers where the quotient could potentially be a decimal. Learning division requires multiple parts and requires advanced number sense. Simultaneous use of focus and memory leads to problems in performing division. Parents and teachers are required to spend more time in teaching division. Due to lack of tools for easy teaching of division, children may end up with math phobia which not only obstructs their growth, but also their academic life. As a result, elementary students may not be as highly motivated and may not enjoy learning. The students often do not put much effort into learning and may not even attempt to learn. The students may quickly fall behind in school or in other academic curriculums.

Educators simply do not teach students efficient means of learning division. Teachers are burdened by large numbers of students and they are not able to effectively work with each student individually. The students are left to learn the division on their own, or request help from a parent or relative. This is not only time consuming, but also embarrassing for students. Visual representation of division problems can help students to easily learn division, but tools for providing such visual representation do not exist in the state of the art. Therefore, both teachers and children desire a teaching tool that can help elementary students in solving and learning division with ease.

Therefore, there exists a long-felt need in the art for a teaching tool that helps students to easily learn division problems. There is also a long-felt need in the art for an education tool that allows users to visually see and practice division problems. Additionally, there is a long-felt need in the art for a teaching tool that assists school age children with memorizing and solving division problems quickly. Moreover, there is a long-felt need in the art for a device that reduces the struggle of elementary students with division problems where the quotient could potentially be a decimal. Further, there is a long-felt need in the art for an education device that helps elementary students to advance into more involved functions such as division of whole numbers. Furthermore, there is a long-felt need in the art for a teaching tool that motivates and encourages students to learn division problems. Finally, there is a long-felt need in the art for a teaching device that reduces effort and time of both teachers and students in encountering division problems.

The subject matter disclosed and claimed herein, in one embodiment thereof, comprises a division problems practice table device. The device has a 14×14 table, similar to a standard multiplication table, but containing division problems and can be in different sizes and can be physical or digital. The table has a grid of fourteen rows and fourteen columns. The first column contains thirteen consecutive numbers starting from zero, wherein the numbers are positioned separately from a second to a fourteenth row and function as a dividend for a division problem. The first row contains thirteen consecutive numbers starting from zero wherein the individual numbers are positioned separately from a second to a fourteenth column, and function as a divisor in the division problem wherein the number zero positioned on intersection of first row and second column is not used as divisor. A division sign is positioned in the cell formed by the intersection of the first column and the first row and an arrow extends across the second column to indicate impossibility of division by zero. The cells formed by intersection of second row and third column to intersection of fourteenth row and fourteenth column include the quotient value when a dividend is divided by a divisor selected from the table.

In this manner, the division problems practice table device of the present invention accomplishes all of the forgoing objectives and provides users with a practice table for dividing numbers where the quotient could be a decimal. The device can be used anywhere and provides a visual representation of division problems. The table device assists school-aged children with memorizing and solving division problems quickly and offers an invaluable teaching tool for educators and elementary students.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a division problems practice table device. The device includes a table having 14-rows×14-columns, similar to a standard multiplication table, but containing division problems. The table has a grid formed by fourteen rows and fourteen columns and the grid contains a plurality of cells. The first column contains thirteen consecutive numbers starting from zero wherein the numbers are positioned separately in the second to fourteenth row and function as dividends. The first row contains thirteen consecutive numbers starting from zero wherein the individual numbers are positioned separately in the second to fourteenth column and function as divisors except the number zero positioned on intersection of first row and second column. A division sign is positioned in the cell formed by the intersection of the first column and the first row and an arrow extends down the second column to indicate impossibility of division by zero. The cells formed by intersection of second row and third column to intersection of fourteenth row and fourteenth column include the quotient value when a dividend of the corresponding row is divided by the divisor of the corresponding column.

In yet another embodiment, a method of visually seeing and practicing division problems is described. The method includes the steps of providing a 14-row×14-column table, a first set of consecutive numbers starting from zero and spanning horizontally across the top row of the table from the second column to the fourteenth column and acting as divisor, a second set of consecutive numbers starting from zero and spanning vertically across the first column of the table from the second row to the fourteenth row and acting as dividend, selecting a number from the second set and then selecting a number from the first set wherein zero from the first set cannot be selected, locating a quotient on division of the number selected from the second set by the number selected from the first set, wherein the quotient is printed in a cell formed by intersection of the row from which the number is selected from the second set and column from which the number is selected from the first set.

In yet another embodiment, a horizontal bar is placed on the repeating digits of quotient wherein the digits are placed after a decimal.

In yet another embodiment, a digital flash card for enabling students to learn division problems is disclosed. The flash card has a front surface and a rear surface, the front surface is configured to display a digital 14-row×14-column table having numbers 0-12 span horizontally across the top row of the table as well as vertically across the first column, a first cell formed by intersection of the top row and the first column has a division sign, the top row has a number zero with an asterisk in the second column and an arrow across the second column. The rear surface has a query box for displaying random division queries or a division query input by a user and a query response box for receiving a response to the division query from the user.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of division-decimal table device of the present invention in accordance with the disclosed architecture;

FIG. 2 illustrates a perspective view showing the division problems teaching aid device of the present invention being used by a teacher and students in accordance with the disclosed architecture;

FIG. 3 illustrates a perspective view showing the division problem table device in the form of a digital flash card in accordance with the disclosed architecture;

FIG. 4 illustrates an exemplary interface of a computer implemented digital division problem flashcard application used for digitally displaying the flashcard of FIG. 3 in accordance with the disclosed architecture;

FIG. 5 illustrates a perspective view showing the division table being displayed in an electronic device in a digital form in accordance with the disclosed architecture; and

FIG. 6 illustrates a flow chart depicting a process of using the division problems teaching aid device of the present invention to locate a quotient in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a teaching tool that helps students to easily learn division problems. There is also a long-felt need in the art for an education tool that allows users to visually see and practice division problems. Additionally, there is a long-felt need in the art for a teaching tool that assists school age children with memorizing and solving division problems quickly. Moreover, there is a long-felt need in the art for a device that reduces struggle of elementary students with division problems where the quotient could potentially be a decimal. Further, there is a long-felt need in the art for an education device that helps elementary students to advance into more involved functions such as division of whole numbers. Furthermore, there is a long-felt need in the art for a teaching tool that motivates and encourages students to learn division problems. Finally, there is a long-felt need in the art for a teaching device that reduces effort and time of both teachers and students in encountering division problems.

The present invention, in one exemplary embodiment, is a method of visually seeing and practicing division problems. The method includes the steps of providing, in one exemplary embodiment, a 14-row×14-column table, a first set of consecutive numbers starting from zero and spanning horizontally across the top row of the table from the second column to the fourteenth column and acting as divisor, a second set of consecutive numbers starting from zero and spanning vertically down the first column of the table from the second row to the fourteenth row and acting as dividend, selecting a number from the second set and then selecting a number from the first set wherein zero from the first set cannot be selected, locating a quotient on division of the number selected from the second set by the number selected from the first set wherein the quotient is printed in a cell formed by intersection of the row from which the number is selected from the second set and the column from which the number is selected from the first set.

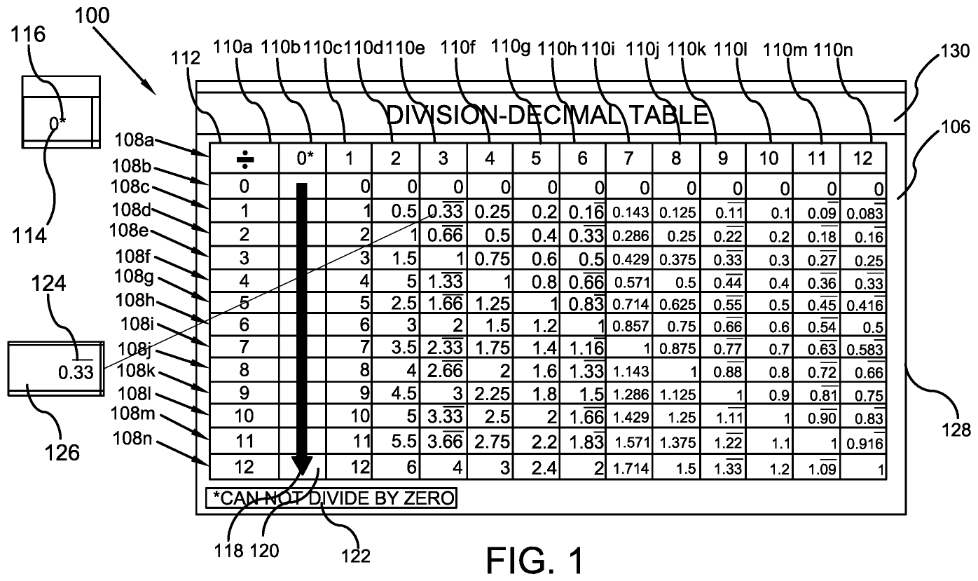

Referring initially to the drawings, FIG. 1 illustrates a perspective view of one potential embodiment of a division-decimal table device of the present invention in accordance with the disclosed architecture. The division-decimal table device 100 of the present embodiment is designed to be used by students for learning division problems and practice easily with math problems. The device 100 can also be used by teachers as a teaching tool for easily teaching division problems. The device 100 is uniquely designed to have an appearance of a standard multiplication table that allows the students to visualize the division problems. More specifically, the device 100 has a laminated thick tear-resistant paper or cardboard 102 having, for example, a 14-row×14-column table 104 printed thereon. The printed table 104 is laminated by a transparent lamination paper 106 for protecting the printed table from physical damage and wearing off while providing users (both teachers and students) a clear view of the table 104.

The table 104 has, for example, fourteen rows 108a-n and fourteen columns 110a-n arranged in a grid to form the table 104. The top row 108a has the numbers 0-12 spanning horizontally across the top of the table 104 in columns 110b-n and the first column 110a has the numbers 0-12 vertically extending down the rows 108b-n. The first cell 112 made by the intersection of the top row 108a and first column 110a has the division sign indicating that the table 104 is used for division. The second column 110b has the number “0” 114 in the top row 108a positioned to the right of the division sign wherein the number “0” has an asterisk 116 as well as an arrow 118 underneath the number “0” sign 114 that reaches all the way down to the number twelve written in the cell 120 made the by intersection of bottom (fourteenth) row 108n and the second column 110b. The asterisk 116 and the arrow 118 are positioned to allow a user to indicate that the numbers underneath the division sign cannot be divided by zero. As an instruction, the description 122 “can't divide by zero” of the asterisk 116 is printed on the bottom left of the cardboard 102. It is to be appreciated that the top row can have any range of sequential numbers, for example, 0-10, 0-15, 0-20, 0-25, 1-10, 1-12, 1-15, 1-20, 1-25, etc. Further, the first column can have any range of sequential numbers, for example, 0-10, 0-15, 0-20, 0-25, 1-10, 1-12, 1-15, 1-20, 1-25, etc.

Each cell, formed by intersection of rows 108b-n and columns 110c-n, contain a quotient value indicating the quotient value formed by dividing a number placed in a cell formed by the corresponding row and the first column by a number placed in a cell formed by the corresponding column and the first row. Accordingly, the numbers placed in each cell of the first column 110a across rows 108b-n function as dividends and the numbers placed in the first row 108a across columns 110c-n function as divisors. As an example, the quotient value in the cell formed by the row 108i and the column 1101 has the value 0.7 as the dividend is number “7” printed on the cell made by the first column 110a and the row 108i. The divisor in this case is the number “10” printed in the cell formed by the column 1101 and the first row 108a. Similarly, a student can easily divide the numbers written in the first column with the numbers written in the first row without any effort and trouble.

In math, there are some non-terminating quotients and the device 100 of the present invention accommodates and displays the non-terminating quotients and are indicated by a horizontal bar 124 above the non-terminating and repeating numbers. As an example, the quotient value in the cell 126 is 0.33 has a horizontal bar above “33” indicating that “33” will be repeated when the number “1” from the first column 110a is divided by number “3” from the first row 108a.

The printed quotients, dividends and divisors can be 2D or 3D printed and can be in the same or different color. Preferably, the rear surface 128 of the cardboard 102 has a magnetic surface or any other hanging means to hang the device 100 on a suitable mounting hook or surface. The device 100 can have a title 130 such as “Division-decimal table” for branding and marketing purposes.

The device 100 can be used by any student who encounters and requires practice with math problems which include both a whole number and a decimal numeral. The decimal numeral system, also called the base-ten positional numeral system, and denary is the standard system for denoting integer and non-integer numbers. It is the extension to non-integer numbers of the Hindu-Arabic numeral system. The whole numbers are set of real numbers that includes zero and all positive counting numbers, which excludes fractions, negative integers, fractions, and decimal numerals. For example, 1.375 being a decimal value is not a whole number. Thus, the device 100 offers an invaluable teaching tool for educators for easily teaching division that incorporates whole numbers and decimal numerals. It is to be appreciated that the table 104 includes a combination of whole numbers and decimal numerals.

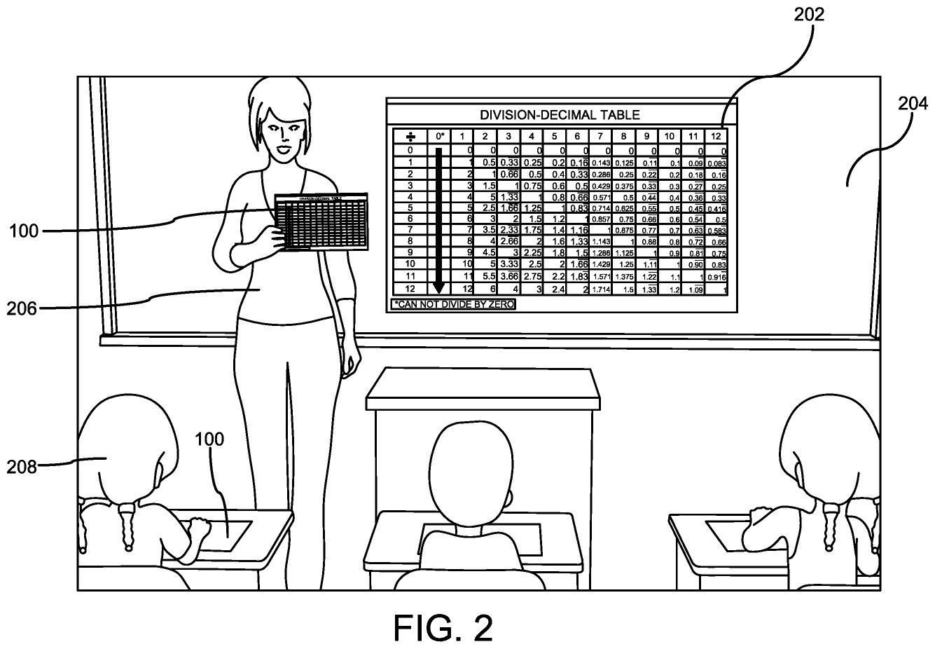

FIG. 2 illustrates a perspective view showing the division problems teaching aid device of the present invention being used by a teacher and students in accordance with the disclosed architecture. The teaching aid device 100 can come in different sizes and as illustrated, the table device printed in the form of a chart paper 202 is releasably attached or hung on a wall or a board 204. The carboard version 100 is held by a teacher 206 for instructing the students 208, wherein each student may have an individual copy of the device 100.

It should be appreciated that the device 100 gives a head start to the students by providing visualization and helps them practice dividing whole numbers and decimal numerals. Further, the teacher 206 can easily teach the division problems of even complicated numbers. In some embodiments, the device 100 can be a part of curriculum for elementary students. Further, it should be noted that the device 100 can be designed to include any number of numerals not necessarily starting from 0 or 1 such that even adults can use them for doing calculations easily.

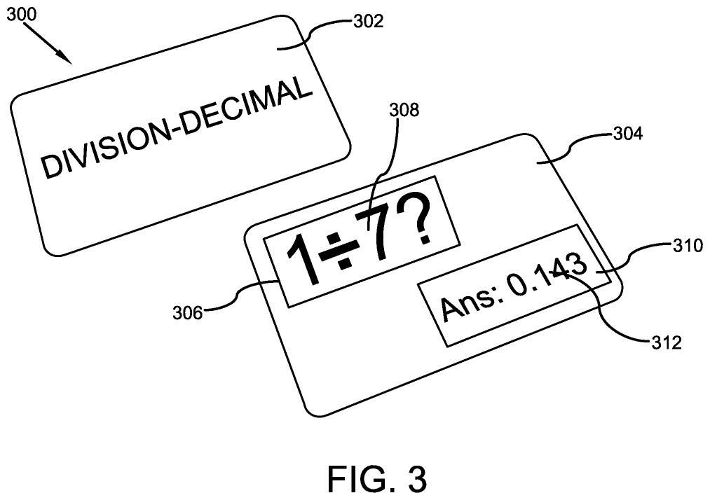

FIG. 3 illustrates a perspective view showing the division problem table device in the form of a digital flash card in accordance with the disclosed architecture. In the present embodiment, the inventive device is in the form of a digital flash card 300 having a digital front surface 302 and a digital rear surface 304. The digital rear surface 304 is configured to display a query box 306 displaying a division query 308 and an answer box 310 configured to receive a response 312 from a user. More specifically, the query box 306 displays random queries allowing a user to practice and the answer box 310 is a touch sensitive display for enabling a user such as a student to input response to the query 308. In cases, where the response is correct, answer box 310 may flash in green color, and if the response is incorrect, may flash in red color.

The front surface 302 is configured to display the division table when the response of the user is received in the answer box 310. When the digital flash card 300 is not used, the displays 306, 310 are automatically turned off for power conservation. The flash card 300 can be used outside a classroom and at home and may be used during travel, thus, ensuring that the students learn and practice the division problems.

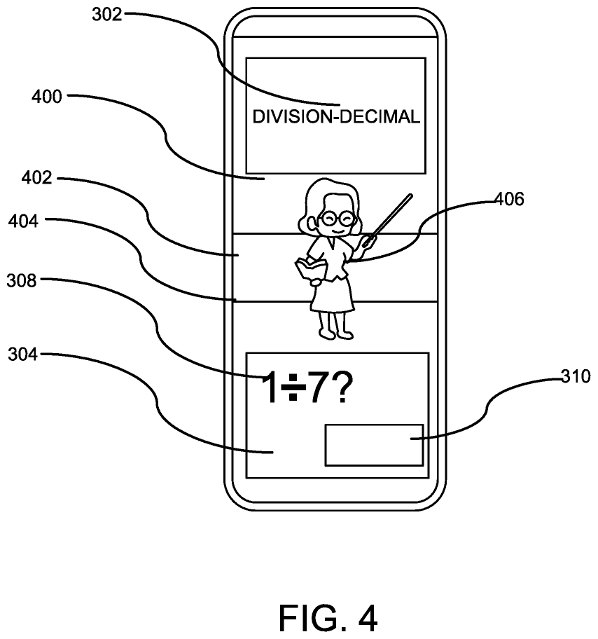

FIG. 4 illustrates an exemplary interface of a computer-implemented digital division problem flashcard application used for digitally displaying the flashcard 300 of FIG. 3 in accordance with the disclosed architecture. In the present embodiment, a computer-implemented application is provided and is configured to display an interface 400 displaying the digital front surface 302 and rear surface 304 on display 404 of a handheld electronic device 402. A user can use the touch sensitive display 404 or any other input means such as a keyboard or keypad based on type of the handheld electronic device 402 to input the desired response into the box 310 to the query 308 displayed on the rear surface 304.

It should be noted that a processor of the electronic device 402 is configured to execute the instructions stored in the computer implemented application for providing the desired interfaces for learning and teaching the division problems described in other embodiments of the present invention. For engagement and increasing interactivity, a logo, or a teacher avatar 406 is displayed on the interface 400.

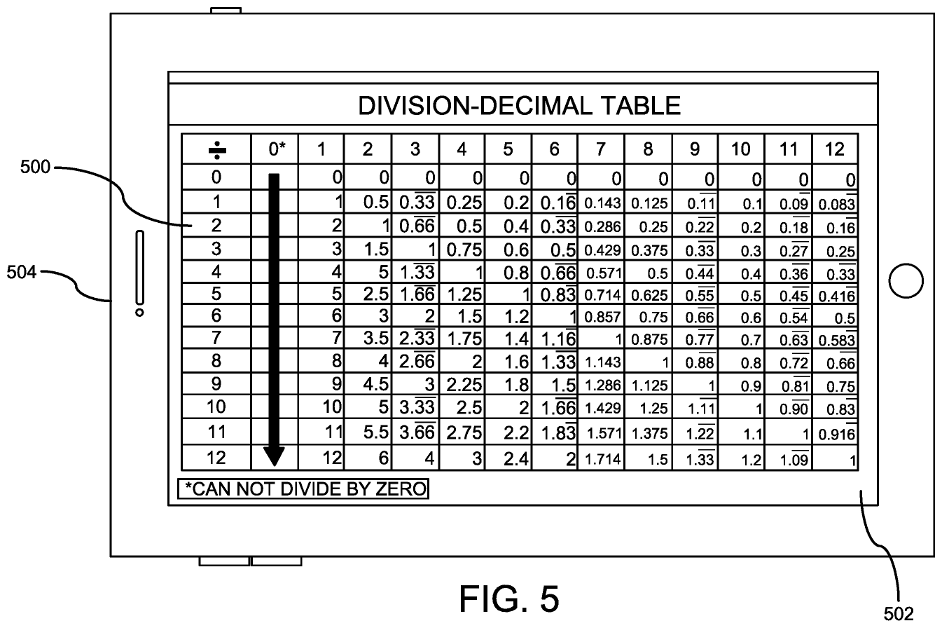

FIG. 5 illustrates a perspective view showing the division table 100 being displayed in an electronic device in a digital form in accordance with the disclosed architecture. In the present embodiment, a digital version 500 of the division table device 100 is displayed on the display device 502 of the electronic device 504. The digital version 500 can be easily accessed and downloaded in the internal memory of the electronic device 504 for easy usage.

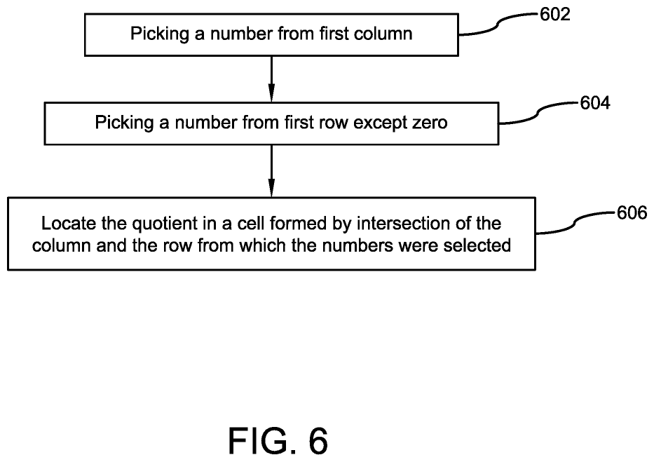

FIG. 6 illustrates a flow chart depicting a process of using the division problems teaching aid device of the present invention to locate a quotient in accordance with the disclosed architecture. Initially, a number between 0 and 12 is picked from the first column by a user (Step 602). The number is considered to be a dividend for a division problem. Then, a corresponding divisor is chosen from the first row except selection of zero as division of a number by zero is infinite (Step 604). Finally, the quotient on dividing the dividend by the divisor is located in a cell formed by intersection of the row and the column from which the dividend and the divisor are selected (Step 606).

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “division problems teaching aid device”, “teaching aid device”, “division-decimal table device”, “system”, “digital flash card”, and “device” are interchangeable and refer to the division problems teaching aid device 100, 300, 500 of the present invention.

Notwithstanding the forgoing, the division problems teaching aid device 100, 300, 500 of the present invention can be of any suitable size and configuration as is known in the art without affecting the overall concept of the invention, provided that it accomplishes the above stated objectives. One of ordinary skill in the art will appreciate that the division problems teaching aid device 100, 300, 500 as shown in the FIGS. are for illustrative purposes only, and that many other sizes and shapes of the division problems teaching aid device 100, 300, 500 are well within the scope of the present disclosure. Although the dimensions of the division problems teaching aid device 100, 300, 500 are important design parameters for user convenience, the division problems teaching aid device 100, 300, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A division-decimal table teaching device comprising:
a printed table arranged in a grid having a plurality of rows and a plurality of columns;
wherein said plurality of rows having at least ten rows and said plurality of columns having at least ten columns;
a top row having sequential numbers between 0 and 25 spanning horizontally in a left to right orientation;
a first column having sequential numbers between 0 and 25 spanning vertically in a top to bottom orientation;
wherein said grid having at least 100 cells wherein each cell is an intersection corresponding to one row and one column;
wherein a number in said first column represents a dividend;
wherein a number in said top row represents a divisor;
wherein each number in said each cell represents a quotient resulting from an intersection of a corresponding said dividend divided by a corresponding said divisor; and
further wherein said table displays a plurality of quotients having a combination of whole numbers and decimal numerals.

2. The division-decimal table of claim 1, wherein said printed table having a laminated transparent outer layer for protecting said printed table.

3. The division-decimal table of claim 1, wherein said top row having sequential numbers between 1 and 12 spanning horizontally in a left to right orientation, and further wherein said first column having sequential numbers between 1 and 12 spanning vertically in a top to bottom orientation.

4. The division-decimal table of claim 1, wherein said top row having sequential numbers between 0 and 12 spanning horizontally in a left to right orientation, and further wherein said first column having sequential numbers between 0 and 12 spanning vertically in a top to bottom orientation.

5. The division-decimal table of claim 1, wherein said top row having sequential numbers between 1 and 15 spanning horizontally in a left to right orientation, and further wherein said first column having sequential numbers between 1 and 15 spanning vertically in a top to bottom orientation.

6. The division-decimal table of claim 1, wherein said top row having sequential numbers between 0 and 15 spanning horizontally in a left to right orientation, and further wherein said first column having sequential numbers between 0 and 15 spanning vertically in a top to bottom orientation.

7. The division-decimal table of claim 1, wherein a portion of said plurality of quotients having non-terminating quotients.

8. The division-decimal table of claim 7, wherein said non-terminating quotients having at least one repeating decimal.

9. The division-decimal table of claim 8, wherein said at least one repeating decimal having a horizontal bar displayed thereabove.

10. The division-decimal table of claim 7, wherein another portion of said plurality of quotients having terminating quotients.

11. The division-decimal table of claim 9, wherein said dividends, said divisors, and said quotients are 2D printed.

12. The division-decimal table of claim 9, wherein said dividends, said divisors, and said quotients are 3D.

13. The division-decimal table of claim 9, wherein said dividends, said divisors, and said quotients are electronic digital numerals.

14. The division-decimal table of claim 1, wherein each said cell is a flash card.

15. The division-decimal table of claim 1, wherein each said cell is a digital flash card.

16. A division-decimal table teaching device comprising:
a printed table arranged in a grid having a plurality of rows and a plurality of columns;
wherein said plurality of rows having at least twelve rows and said plurality of columns having at least twelve columns;
a top row having sequential numbers between 0 and 12 spanning horizontally in a left to right orientation;
a first column having sequential numbers between 0 and 12 spanning vertically in a top to bottom orientation;
wherein said grid having at least 144 cells wherein each cell is an intersection corresponding to one row and one column;
wherein a number in said first column represents a dividend;
wherein a number in said top row represents a divisor;
wherein each number in said each cell represents a quotient resulting from an intersection of a corresponding said dividend divided by a corresponding said divisor;
wherein said table displays a plurality of quotients having a combination of whole numbers and decimal numerals; and
further wherein a portion of said plurality of quotients having non-terminating quotients.

17. The division-decimal table of claim 16, wherein said non-terminating quotients having at least one repeating decimal, and further wherein said at least one repeating decimal having a horizontal bar displayed thereabove.

18. A division-decimal table teaching device comprising:
a printed table arranged in a grid having a plurality of rows and a plurality of columns;
wherein said plurality of rows having at least twelve rows and said plurality of columns having at least twelve columns;
a top row having sequential numbers between 0 and 15 spanning horizontally in a left to right orientation;
a first column having sequential numbers between 0 and 15 spanning vertically in a top to bottom orientation;
wherein said grid having at least 144 cells wherein each cell is an intersection corresponding to one row and one column;
wherein a number in said first column represents a dividend;
wherein a number in said top row represents a divisor;
wherein each number in said each cell represents a quotient resulting from an intersection of a corresponding said dividend divided by a corresponding said divisor;
wherein said table displays a plurality of quotients having a combination of whole numbers and decimal numerals;
wherein a portion of said plurality of quotients are non-terminating quotients and another portion of said plurality of quotients are terminating quotients; and
further wherein said dividends, said divisors, and said quotients are electronic digital numerals.

19. The division-decimal table of claim 18, wherein each said cell is a flash card.

20. The division-decimal table of claim 18, wherein each said cell is a digital flash card.
